(19) United States
(12) Patent Application Publication
(10) Pub. No.: US 2008/0233308 A1
(43) Pub. Date: Sep. 25, 2008

(54) Production of Means For Improving the State of Systems and Materials

(76) Inventor: Pasquale Mosaico, Flawil (CH)

Correspondence Address: FITCH EVEN TABIN AND FLANNERY, 120 SOUTH LA SALLE STREET, SUITE 1600, CHICAGO, IL, 60603-3406, US

(21) Appl. No.: 11/997,109

(22) PCT Filed: Jun. 30, 2006
(86) PCT No.: PCT/CH2006/000351

§ 371 Date: Jan. 28, 2008

(30) Foreign Application Priority Data
Jul. 28, 2005 (CH) 1263/05
Dec. 20, 2005 (CH) 2026/05

(51) Int. Cl. B05D 3/06

(52) U.S. Cl. 427/595

(57) ABSTRACT

The invention relates to a method for manufacturing means for improving the condition or function of systems and substances, as well as biological, natural or technical systems, and is used for optimising conditions or processes and/or for increasing resistance to harmful environmental influences.

The method according to the invention uses light, sound, electricity and magnetism as carriers of client- and condition-specific information.

The method is characterised by the following steps:
a) mixing different minerals
b) reducing the particle sizes of these minerals to micro- or nano-particles
c) activating the reduced mineral particles before or after
d) permanent fixing/storage of information on the mixture
e) application of introduction of the activated and informed mixture onto or into a substrate.

The invention relates to a method for the manufacture of means for improving the condition of systems, particular for the improvement of condition and/or function and/or performance, and for optimising the function of biological systems or even of water or technical substances or technical systems. The invention also relates to the use of such means.

A method is known for using biophotons for detecting conditions and/or for influence conditions of biological systems. This is achieved mainly by the emission of ultra-weak photon flows from excited cells or tissues and their measurement. For example, WO 01/01114 discloses a method for determining the germinative capacity of seed grains by irradiating seed grains with light and measurement of at least one characteristic size of the light emitted by the seed grains after the end of irradiation. However, such a light can also be emitted and determined without external excitant. Germinative capacity may be deduced from the determined size, if necessary with the addition of further values, for example the water content of the grains.

However, it should also be possible to use biophotons as measured values for detecting specific conditions of animal or human tissues, and even for influencing them.

The body's own bio-information, or bio-information relating to specific substances, may also be used in bioresonance therapies by recording, processing such bio-information and feeding it to back to the body or substance after processing, even if this takes place with a time delay (DE 29709094 U1). Body or substance information may derive from the body concerned (e.g. according to EP-A-1424099) or from third bodies which have a better condition (e.g. according to EP-A-0714027). DE-A-3110915 discloses a therapy device for treating water or biological systems with magnetic fields or electromagnetic radiation.

Intensive research is being carried out in order to be able to change certain conditions which cannot be influenced by classic means (or cannot even be explained).

AT-B-409930 discloses a device for influencing metallic or metal powders or foils or leaves containing metal pigments. What is provided is a device for influencing metallic foils which comprise a single metallic winding which is earthed at one end and is connected to an earth cable or a neutral conductor at the other end. This other end is connected to a metal plate on which is arranged a tank containing water rotating clockwise. Polymer foils vacuum metallised with aluminium are known from the same author, in which the atomic lattice of the aluminium is to have a modified structure so that they have storage properties and can be used, for example, for suppressing fields. Furthermore, frequencies can be programmed on the crystal lattices, for example in order to render electrosmog on the source harmless by modulation.

In order to be able to charge batteries quickly a method is known for introducing nanoparticles.

In so-called TDP infrared lamps a specific ceramic is heated and specific frequencies of the mineral frequencies (CN 9710077-5) present on the ceramic are irradiated. Such ceramic may also be structured in the nano-range, for example optical modulators having silicon particles. Up to 10 billion light pulses per second should be possible by means of this so-called “silicon” or “nano photonics” technology (Luxtera/CA, USA http://www.luxtera.com/technology_faq.htlm).

The object of the invention is therefore to develop a method for manufacturing means for improving the condition of systems and substances, particularly natural substances or biological systems, which means can be used directly on the biological system. Such means are to be manufactured which can be used preferably directly and without further coupling aids. Such improvement in condition should also be achievable in technical systems and/or technical substances. Condition improvements should also include function and/or performance improvements.

The object is achieved with the characteristics of claim 1. Deviating from the state of the art, a plurality of minerals, if necessary with the addition of further metallic or inorganic components, is applied to a substrate. A mixture is used from at least 2 different mineral substances, preferably up to approx. 30. At least one mineral will here be represented in a proportion of at least 5%, silicon for example. The mineral mixture serves as a storage medium for (among other things photon) energy and as a storage medium for a source code of electromagnetic, electro-optical, opto-electronic or quantum optical information and a control logic. The control logic controls the mode of operation of the means for the reception, modulation and discharge of the suitable user-specific quantity of photons and information and other possible energy and information units during the use of the means. The transmission of photons, other particles, waves and the information connected with them may act independently/actively by means of new information, or may modulate in an amplifying manner (“constructive interference”) or compensating manner (“destructive interference” or “counter-noise”), existing individual frequencies or ranges or transversal or longitudinal waves of the holographic field of the relevant user system or substance, or even its entire field.

Environmentally conditioned or the user's own photons, energy or information units or other particles irradiated and received by the means, and information relating to them, may if necessary be corrected by the constructive and destructive interference mentioned and returned to the environment or user. The frequencies sent move primary within the tera and higher GHz frequency range, but other transversal or even longitudinal waves or eddies or plasmons or particles may also be used, for example. The information/frequencies connected to the holographic field of each user system or substance by the means are modulated intelligently with high (light or photon) energy and transmitted in the modulated form to each user system or substance. There they give rise to condition and/or function and/or performance improvements of the user system or substance concerned, e.g. indirectly by actively influencing the electron behaviour of the atoms present. The connection mentioned is also made without lasers or the like of additional transmission means or coupling aids, but may become more effective by the addition of the same.

The optimum distance of action should generally be smaller than 1.5 m, but may also be extended. Direct body contact by means of coupling aids is not necessary but may be appropriate for improving performance.

Before mixing and application, the minerals are subjected to crushing as a result of which the particle size is reduced to less than 1 mm, preferably below 200 nm, in order to reach micro- or nano-particle. This is followed by permanent energetic activation or charging of the mineral mixture by electromagnetic or electro-optical processing. A source code is also implemented on the mixture, which code is introduced in the form of specific frequency spectra. For this purpose a frequency generator is used (we use a device similar to a laser, to whose carrier frequency the specific information is modulated in the range of 600 nm, then “burnt” into the substrate. Is this method covered by the expression “frequency generator”?). Primarily the crystals of the minerals are “impregnated” with this information (finer than at atom lattice level). As a helpful analogy mention is made of the storage of information on DVD's containing silicon.

Before or after the electromagnetic or electro-optical processing, the mineral mixture is applied to a substrate or introduced into it. The mixture may be stretchable, capable of being sprinkled or sprayed, it may be water and friction resistant and, if necessary, also capable of being absorbed.

Further preferred embodiments are disclosed in the dependent claims. For example, the substrate may consist, among other things, of paper, plastic and/or metal or wood or other organic or inorganic materials. The use of noble metals or, in particular, of single or multi-layer anodised aluminium preferred for performance improvement, whose surface contains at least crystalline areas, is also suitable, for example.

For performance improvement the substrate may also have a multi-layer sandwich design and/or contain structures for receiving the processed mineral mixture.

For performance improvement geometric structures may be applied both to the mixture and to the substrate and/or accompanying material, for example in the form of a DNS double helix. Such a double helix or other structures or elements serve as antennae with a size extending to the two-digit centimetre range, this dimension depending on the wavelengths to be transmitted or received for achieving optimum efficiency of the active media, even in the non-transdermal range.

The relationships are considered between activated active media, antenna size and energy bundling, in order to cover an entire spectrum from the fine substance range (nano-range, digital data) to the coarse substance range (centimetre range). The shape of the antennae may, for example, be embossed in the mineral mixture, engraved in the substrate or printed onto it, or may be present as a metal structure (classic antenna).

If necessary the minerals may also be supplemented by organic substances, which are similarly crushed and processed (for example, also L-amino acids, etc.).

Similarly, proteins or amino acids (if necessary all known) human genes or other genes, cell or cell constituents, among other things, can be arranged on glass, nylon or other substrates (micro-arrays, gene chips), and are therefore used with the means.

The means may also contain a coat of paint which absorbs photons, for example a black paint (photon trap). Similarly, inner or outer layers of the means may be coated with noble metals (e.g. gold, silver, platinum or mixtures thereof) and/or may have aluminium coatings.

A further object of the invention consists in indicating the use of means of improving the condition of systems. This object is achieved with the characteristics of claim 12.

If necessary coupling aids may be used such as plaster, clips, electrodes, light wave conductors, conductors, sound weave conductors or cords, in order to improve the use and effect of the means.

To improve the action or performance of the means additional energy or photon suppliers and additional electrical or electromagnetic carrier waves or magnets may also be used for information and energy transmission, particularly in the form of electromagnetic fluxes or fields, signals, etc., e.g. by means of batteries or sound or light sources (photon pumps).

The means are used for improving the condition, and in particular for optimising the condition of biological, but also of non-biological systems. This relates preferably to the well-being or resistance of plants, animals and humans, e.g. improvement in the growth of plants or the increase in resistance to polluting environmental influences. Furthermore, a change, reduction or reversal of the loading intensity or (undesirable) side effects of technical and other devices and apparatus, environmental influences or harmful substances, can be brought about. A progressive normalisation of the skin resistance or volume resistance, or an alleviation of pain conditions ion humans or in animals, or even reduced crystal formation in water, corresponding more closely to natural well water (it remains or becomes soft), can also be achieved, for example.

If necessary the finished means may also be used as an information memory after its completion, by third parties, e.g. homeopathic doctors or non-medical practitioners, for example by digital recording patient- or user-specific (homeopathic) information specially tested beforehand on the patient and determined as helpful. It may then be used as a permanent transmission medium for the patient or other user by simply carrying the means close to the body.

This use of the means may be an alternative to (homeopathic) alcohol-water solutions or milk-sugar preparations that are common elsewhere, have to be administered orally and are provided with curing information

User- or environmentally specific information can be specifically received, modulated and retransmitted by means of the intrinsically known surface properties of the minerals as micro- or nano-antennae (see www.ftd.de/rd/1111217801336. html) or as prisms or micro- or nano-mirrors. Such micro- or nano-antennae or prisms or micro- or nano-mirrors are, optimally, less than 200 μm and transmit data/information stored in the mixture according to their special alignment.

The invention is described in greater detail in the following in an exemplary embodiment.

A mixture of 10 different minerals contains, for example, silicon in a proportion of 5% to 20%, and approx. 5-25% (is 2-25% also appropriate???) common salt (NaCl).

The minerals are also reduced to particle sizes of 200 nm max. by crushing, for example on rolling mills and in agitator mills, then activated or energised. Here a permanent photon charge is introduced into the crystal lattice. The minerals are optically modulated. Rod-shaped molecular arrangements formed during reduction in the nanostructure act as antennae or prisms, and may receive as well as radiate light and other frequencies or waves, for example on a plant to accelerate its growth. The mineral mixture may also be applied by spreading and may be abrasion and water resistant due to the special mixing ratios, and hence easy to use.

The activated and processed mineral mixture is applied adhesively to a substrate of paper in credit card format and the substrate is laminated by the normal method with the mineral mixture for protecting against damage.

A flat metallic coat formation of the substrate, e.g. two coats of anodised aluminium and/or one or two gold-plated inner and outer layers, are possible. The thickness of the substrates should be a maximum of approx. 2 mm.

Alternatively the envelope of the means may be designed as a decorative container, e.g. of metal, noble metal or ceramic, for example in the form of a clock or jewelry box.

The means thus obtained for improving condition may be arranged underneath plant bowls, for example, in order substantially to improve the growth of these plants, e.g. garden cress.

The method according to the invention uses light, sound, electricity and magnetism as carriers of client- and condition-specific information.

1. A method for manufacturing a device which improves a condition of systems and substances, the method comprising:
a) mixing different minerals to provide a mineral mixture;
b) reducing particle size of the minerals to provide a mixture of mineral particles with reduced size and having approximately the same particle size;
c) energy activating the reduced mineral particles to provide an activated mixture;
d) implementing a source code on the mixture in a form of specific frequency spectra; and
e) applying a mixture selected from the group consisting of the activated mixture, mixture provided with the source code, and a combination of both mixtures to a substrate.

2. The method according to claim 1, wherein in a) at least 2 different minerals are mixed together into the mineral mixture.

3. The method according to claim 2, wherein metallic components are further introduced into the mineral mixture.

4. The method according to claim 2, wherein at least one mineral in the mineral mixture is in a proportion of at least 5%.

5. The method according to claim 1, wherein the activating c) comprising one of the group consisting of energizing, electromagnetic processing, and electro-optical processing, in which a permanent energetic charge is introduced into crystal lattices of the minerals providing information.

6. The method according to claim 5, wherein the information is supplied by a frequency generator.

7. The method according to claim 5, wherein the energizing takes place over a period of at least one hour.

8. The method according to claim 1, wherein the substrate is elected from a group consisting of paper, plastic and metal, which may be laminated after applying the mineral mixture.

9. The method according to claim 1, wherein the mineral mixture is spread, and is abrasion and water resistant.

10. A device for improving the condition of systems, comprising a substrate with a mixture of energized micro- and nano-particles applied to the substrate according to claim 1.

11. (canceled)

12. The device according to claim 10, wherein the systems are biological and technical systems, and conditions of the systems are optimized by increasing resistance of the systems to environmental influences and other harmful side effects.

13. The method according to claim 1, wherein at least 10 different minerals are mixed together in the mineral mixture

14. The method according to claim 1, wherein organic substances are further introduced into the mineral mixture.

15. The method according to claim 4, wherein the at least one mineral in the mineral mixture is silicon.

16. The method according to claim 5, wherein the permanent energetic charge is a photon charge.

17. The method according to claim 1, wherein the mineral mixture is sprayed onto the substrate.
